(19) United States
(12) Patent Application Publication
(10) Pub. No.: US 2009/0190871 A1
(43) Pub. Date: Jul. 30, 2009

(54) AUTOMATIC TRANSMISSION

(75) Inventor: Thierry BLIN, Strasbourg (FR)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/361,479

(22) Filed: Jan. 28, 2009

(30) Foreign Application Priority Data
Jan. 29, 2008 (EP) 08001593.6

(51) Int. Cl. F16C 35/00

(52) U.S. Cl. 384/438

(57) ABSTRACT

An automatic transmission includes, but is not limited to a main case including, but not limited to a guidance for an output shaft. The guidance comprises at least one bearing. In order to make sure that the bearings do not move out of their location without reducing the distance between the bearings, a spacer is fixed between the bearings and the diameter of the bearings decreases with increasing distance from the spacer.

### CROSS-REFERENCE TO RELATED APPLICATION

This application claims priority to European Patent Application No. 08001593.6, filed Jan. 29, 2008, which is incorporated herein by reference in its entirety.

### TECHNICAL FIELD

The invention concerns an automatic transmission with a main case including a guidance for an output shaft, the guidance comprising at least one bearing.

### BACKGROUND

An automatic transmission is known from the document DE 11 2004 000 653 T5. The document EP 1 643 160 A2 is concerned with the mounting of a transmission comprising an output shaft and at least one bearing in a case. The bearing is configured to position axially the output shaft during the mounting of the transmission.

The current design of automatic transmissions does not include any shoulder for retaining the bearing. This design was chosen because its absence facilitates the rear machining and because of the bearing lifetime. A shoulder would reduce the distance between two bearings which would decrease the bearing lifetime.

However, due to the unbalance of the output shaft it may occur at high speed levels that the bearing moves out of its location, thereby pushing the lip seal outside. This leads to transmission leakage and occurrence of important vibration noise.

In view of the foregoing, at least one object of the invention is to make sure that the bearings do not move out of their location without reducing the distance between the bearings. In addition, other objects, desirable features, and characteristics will become apparent from the subsequent summary or detailed description, and the appended claims, taken in conjunction with the accompanying drawings and this background.

### SUMMARY

According to an embodiment of the invention, a spacer is fixed between the bearing(s) and the diameter of the bearing(s) decreases with increasing distance from the spacer.

The embodiments of the invention are based on the understanding that the unbalance level of the output shaft at high speed makes the bearing(s) move in the longitudinal direction even if the bearings are press fit inside the bore. The spacer serves as a stop for the bearing(s). The design of the bearing(s) was modified in order to make them move always towards the stop. As the outer diameter of the bearing(s) decreases from the side which is adjacent to the spacer to the opposite site, the bearing(s) move(s) always towards the stop. This solution is neither complex nor expensive.

In a preferred embodiment of the invention, the spacer is press fit inside the bore. This can be easily realized during the mounting of the transmission. According to the present invention, the spacer is made of aluminum. Aluminum is very well adapted as spacer material because this assures a good press fit strength over a wide range of temperature.

### BRIEF DESCRIPTION OF THE DRAWINGS

The present invention will hereinafter be described in conjunction with the following drawing figures, wherein like numerals denote like elements, and

FIG. 1 shows the current design of the output of an automatic transmission; and

FIG. 2 shows the bearings for the output shaft in an automatic transmission according to an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

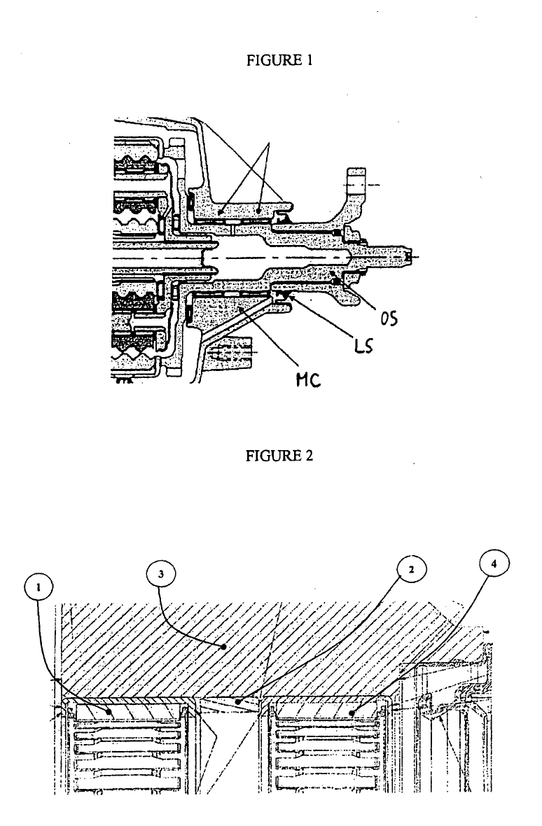

FIG. 1 (prior art) shows the output shaft (OS) of an automatic transmission which extends through an opening in the main case (MC). The guidance of the output shaft (OS) is done by two bearings (B) pressed in the main case (MC). A lip seal (LS) closes the lateral opening in which the bearings (B) are placed.

FIG. 2 shows two bearings 1, 4 for the guidance of the output shaft of an automatic transmission. Between the bearings 1, 4, a spacer 2 is press fit inside the bore 3. The purpose of this spacer 2 is to create a positive stop for the bearings 1, 4. The spacer 2 is made of aluminum in order to avoid a significant loss of press fit strength at varying temperatures.

In order to bloc the bearings 1, 4 against the spacer 2, the bearings 1, 4 have been configured as follows in order to always move towards the spacer 2.

The outer diameter of the bearings 1, 4 decreases with increasing distance from the spacer 2. With other words, the bigger outer diameter of the bearings 1, 4 is located on the side of the spacer. Thus, the tapered outer diameter of the bearings makes them move always towards the spacer 2 which is press fit inside the bore 3.

This allows the ability to keep the case design and the distance between the bearings 1, 4, the last fact assuring that the lifetime of the bearings 1, 4 is not reduced.

While at least one exemplary embodiment has been presented in the foregoing summary or detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary or detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An automatic transmission, comprising:
an output shaft;
a main case comprising a guidance for the output shaft, the guidance comprising at a plurality of bearings; and
a spacer is fixed between the plurality of bearings and a diameter of the plurality of bearings decreases with an increasing distance from the spacer.

2. The automatic transmission according to claim 1, wherein the spacer is press fit inside a bore.

3. The automatic transmission of claim 2, wherein the spacer is made of aluminum.
